(19) United States
(12) Patent Application Publication
(10) Pub. No.: US 2021/0200267 A1
(43) Pub. Date: Jul. 1, 2021

(54) RIGID CARRIERS FOR PLASTIC LAYERS OF DEVICES

(71) Applicant: HEWLETT-PACKARD DEVELOPMENT COMPANY, L.P., Spring, TX (US)

(72) Inventors: Timothy J. SUTHERLAND, San Diego, CA (US); Philip H. WRIGHT, San Diego, CA (US)

(73) Assignee: HEWLETT-PACKARD DEVELOPMENT COMPANY, L.P., Spring, TX (US)

(21) Appl. No.: 16/075,657

(22) PCT Filed: Apr. 6, 2017
(86) PCT No.: PCT/US2017/026404

§ 371 Date: Aug. 5, 2018

(51) Int. Cl. G06F 1/16; B32B 7/12; B32B 27/08; B32B 37/12

(52) U.S. Cl. CPC G06F 1/1609; B32B 7/12; B32B 27/08; B32B 2037/1253; B32B 2457/208; B32B 2307/412; B32B 2307/584; B32B 37/12

(57) ABSTRACT

In some examples, an assembly includes a plastic layer to cover a surface of a display panel, a rigid carrier to support the plastic layer, and a removable fastener to attach the plastic layer to the rigid carrier, the removable fastener to release the rigid carrier from the plastic layer.

### BACKGROUND

A display device used with a portable electronic device can include an outer protective layer that covers a display surface of a display panel in the display device. The outer protective layer can be formed of a glass, which can break when the portable electronic device is dropped, or a force is otherwise imparted on the glass protective layer.

### BRIEF DESCRIPTION OF THE DRAWINGS

Some implementations of the present disclosure are described with respect to the following figures.

FIGS. 1-4 are schematic sectional views of various assemblies at respective different stages associated with manufacturing a device including a display panel, according to some examples.

FIG. 5 is a sectional view of an assembly that includes a display panel, a plastic layer, a transparent rigid carrier, and a removable fastener, according to further examples.

FIG. 6 is a flow diagram of a process of forming a device, according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

To address the issue of using breakable glass cover in a display device, a plastic cover layer can be used instead to cover the display surface of a display device. However, unlike glass, the plastic cover layer is not stiff (i.e., the plastic layer is pliable such that it is easily bent), which can make handling of an assembly including the plastic cover layer difficult during manufacture of a display device (or manufacture of an electronic device that includes the display device).

In some cases, a display panel itself can include a plastic housing, such that the display panel is also pliable. A display panel that has a plastic housing can be referred to as a “plastic display panel.” An example of a plastic display panel is a plastic organic light-emitting diode (OLED) display panel. Once the plastic cover layer is attached to the plastic display panel, the assembly of the plastic cover layer and the plastic display panel remains pliable, which makes handling of the assembly including the plastic cover layer and the plastic display panel difficult, since excessive bending of the assembly of the plastic layer and the plastic display panel may cause warping or damage to the display panel.

In accordance with some implementations of the present disclosure, a releasable rigid carrier is used during the manufacture of a display device. Manufacturing a display device can include assembling various layers of the display device together to form the display device. The rigid carrier can be releasably attached to a plastic cover layer that is used as a protective cover on a display surface of a display panel. An assembly including the rigid carrier and the plastic cover layer is attached to the display panel. At a later stage during the manufacture of the display device, a removable fastener that releasably attaches the rigid carrier to the plastic cover layer can be removed, to release the rigid carrier from the plastic cover layer, which leaves the plastic cover layer attached to the display surface of the display panel.

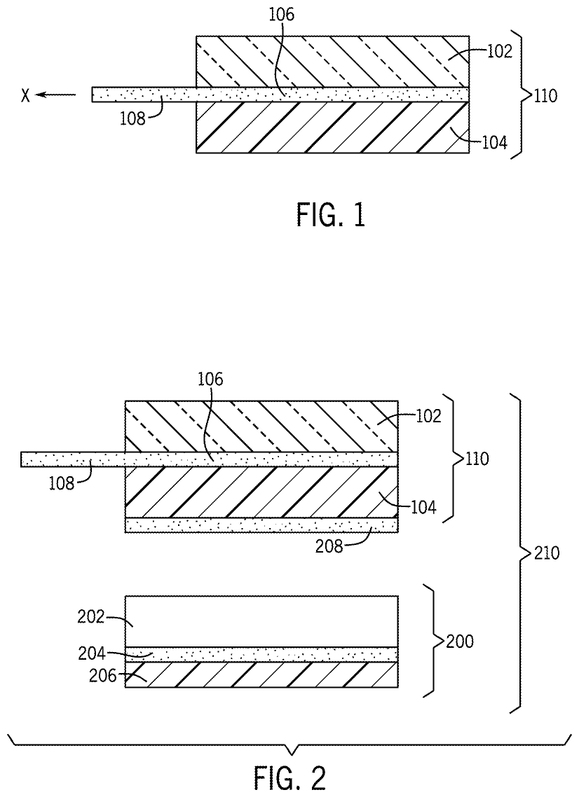

FIGS. 1-4 are schematic sectional views of various assemblies at respective different stages associated with manufacturing a device (e.g., a display device or an electronic device) including a display panel. In some examples, the display panel that is part of the device can be a plastic OLED panel. In other examples, other types of display panels can be used.

In some examples, a display device that is manufactured can be a standalone display device, which is to be operatively connected to another system for use. In further examples, an electronic device that is manufactured can include any of the following: a notebook computer, a tablet computer, a smartphone, a game appliance, a wearable device (e.g., a smart watch, smart eyeglasses, a head-mounted device), or any other type of electronic device that includes a display panel.

Note that the different stages shown in FIGS. 1-4 can be performed by respective different entities, or by the same entity. In further examples, an entity can perform manufacturing relating to more than one of the stages shown in FIGS. 1-4. In other examples, each stage shown in FIGS. 1-4 is performed by a respective different entity. As used here, an “entity” can refer to an enterprise such as a company or an individual.

FIG. 1 shows an assembly that includes a rigid carrier 102 and a plastic lens 104. The plastic lens 104 constitutes a plastic cover layer (or more simply, a “plastic layer”) that is to be provided on a display surface of a display panel. The plastic lens 104 is a transparent lens (transparent to light, including ultraviolet light) that is used to provide a protective layer over the display surface of the display panel. For example, the display panel can be a touch-sensitive display panel, where the user can make touch inputs on the display surface of the display panel. In other examples, the display panel is a non-touch-sensitive display panel.

The plastic lens 104 is to cover the display surface of the display panel to protect the display surface from scratches or other damage during use. In some examples, the plastic lens 104 can be formed of a material that includes a plastic such as acrylic, polycarbonate, and so forth.

An issue associated with use of the plastic lens 104 is that it is pliable, such that when handled the plastic lens 104 can be easily bent, which can cause warping or damage to the plastic lens 104 (or an assembly of the plastic lens 104 and another component, such as a plastic display panel). To address the foregoing issue, the plastic lens 104 is attached to the rigid carrier 102. In some examples, the rigid carrier 102 is formed of a material that includes glass. In other examples, the rigid carrier 102 can be formed of a different rigid material. The rigid carrier 102 in some examples can be formed of a transparent material that is transparent to ultraviolet light, such that ultraviolet light can pass through the rigid carrier 102 and through the transparent plastic lens 104 to a structure below the plastic lens 104 (discussed further below).

The rigid carrier 102 is a temporary structure that is used during the manufacturing process to provide a rigid support for the plastic lens 104 (as well as other pliable structures used during the manufacturing process as discussed further below). As such, the rigid carrier 102 is releasably attached to the plastic lens 104 using a removable fastener. In examples according to FIG. 1, the removable fastener is in the form of a removable adhesive layer 106, which is sandwiched between the rigid carrier 102 and the plastic lens 104. The removable adhesive layer 106 can also be transparent to ultraviolet light in some examples. An upper surface of the removable adhesive layer 106 is adhesively attached to a lower surface of the rigid carrier 102, and a lower surface of the removable adhesive layer 106 is adhesively attached to an upper surface of the plastic lens 104.

As used here, a lower surface of an object refers to a surface that is on a side opposite to an upper surface of the object. The lower surface faces in the first direction, while the upper surface of the object faces in a second direction that is opposite the first direction. Note that in one orientation of the object, the lower surface of the object faces in a downward direction, while the upper surface of the object faces in an upward direction. However, in an upside-down orientation, the lower surface of the object faces in an upward direction, while the upper surface of the object faces in a downward direction. In a different orientation, such as a slanted orientation, of the object, the lower surface of the object faces in a left or right or diagonal direction, while the upper surface of the object faces in a right or left or different diagonal direction.

The removable adhesive layer 106 includes a pull tab 108. A human or machine can grip the pull tab 108 to pull the adhesive layer 106 in a direction X that is generally parallel with the main surfaces (horizontal surfaces shown in the view of FIG. 1) of the rigid carrier 102 and the plastic lens 104. Pulling on the pull tab 108 causes the adhesive layer 106 to be released from the plastic lens 104, such that the rigid carrier 102 can be detached from the plastic lens 104. However, the release of the rigid carrier 102 from the plastic lens 104 does not occur until later in the manufacturing process of a device (display device or electronic device).

The rigid carrier 102 and the plastic lens 104 releasably attached to the rigid carrier 102 by the removable adhesive layer 106 make up a lens sub-assembly 110, which can be used in the next stage of the manufacturing process shown in FIG. 2.

In other examples, instead of using the removable adhesive layer 106, a different type of removable fastener can be used to releasably attach the rigid carrier 102 to the plastic lens 104. For example, the removable fastener can include a releasable clamp to clamp the rigid carrier 102 to the plastic lens 104. The clamp can be actuated between an engaged position (to clamp the rigid carrier 102 and the plastic lens 104 together), and a released position (to release the rigid carrier 102 and the plastic lens 104). In other examples, other types of releasable fasteners can be used.

In the next stage of the manufacturing process, as shown in FIG. 2, the lens sub-assembly 110 that includes the rigid carrier 102 and the plastic lens 104 is attached to a display sub-assembly 200 that includes a display panel 202, a support frame adhesive layer 204, and a liner 206 that covers a lower surface of the support frame adhesive layer 204. The liner 206 covers the lower surface of the support frame adhesive layer 204 that is opposite the upper surface of the support frame adhesive layer 204 that is attached to the lower surface of the display panel 202. The liner 204 is used to temporarily cover the lower exposed surface of the support frame adhesive layer 204 to prevent the support frame adhesive layer 204 from inadvertently sticking to other objects.

The attachment of the lens sub-assembly 110 to the display sub-assembly 200 is performed using another adhesive layer 208 that is provided between the lower surface of the plastic lens 104 and an upper surface of the display panel 202.

In some examples, the adhesive layer 208 includes an optically transparent adhesive that allows viewing of the upper surface of the display panel 202 once the adhesive layer 208 is bonded to the upper surface of the display panel 202. The upper surface of the display panel 202 is the display surface of the display panel 202. The display surface is the surface of the display panel that displays images when the display panel is operated. The display surface of the display panel 202 is also the surface that can accept touch inputs from a user or stylus in examples where the display panel 202 is a touch-sensitive display panel.

In some examples, the adhesive layer 208 includes an optical clear resin (OCR) adhesive layer, a liquid optically clear adhesive (LOCA) layer, or any other type of optical grade adhesive. In some examples, the optically transparent adhesive layer 208 can be cured using ultraviolet light that is passed through the transparent rigid carrier 102, the transparent removable adhesive layer 106, and the transparent plastic lens 104. Curing the adhesive layer 208 using ultraviolet light fixes the adhesive layer 208 such that a permanent bond can be provided between the display panel 202 and the plastic lens 104.

In other examples, the adhesive layer 208 can be a different type of adhesive layer.

In examples according to FIG. 2, the adhesive layer 208 is first bonded to the lower surface of the plastic lens 104, and then the adhesive layer 208 is bonded to the display panel 202. In other examples, the adhesive layer 208 is first bonded to the upper surface of the display panel 202, and then the adhesive layer 208 is bonded to the lower surface of the plastic lens 104.

In FIG. 2, the lens sub-assembly 110 is attached to the display sub-assembly 200, to form a lens-display assembly 210 that is used in the next stage of the manufacturing process, as shown in FIG. 3.

In some examples, the display panel 202 is a plastic display panel, which is also pliable, such that even after attaching the plastic lens 104 to the plastic display panel 202, the lens-display assembly 210 that includes the plastic lens 104 and the plastic display panel 202 is still relatively pliable and difficult to handle. The rigid carrier 102 that is part of the assembly 210 can provide structural support for the lens-display assembly 210 in the next stage of the manufacturing process shown in FIG. 3.

In FIG. 3, the liner 206 that lines the lower surface of the support frame adhesive layer 204 is removed, and a lens-display assembly 210′ (which is the lens-display assembly 210 with the liner 206 removed) is attached to a support frame 302 of a device (display device or electronic device) using the support frame adhesive layer 204. The support frame adhesive layer 204 is bonded to an upper surface of the support frame 302. In some examples, the support frame 302 can be a midframe of the device. The midframe of the device can be a frame that is located inside the display device, within the outer housing of the device. In further examples, the support frame 302 can be part of the outer housing of the device.

The support frame 302 can be formed of a metal or another rigid material, such as hard plastic.

Once the lens-display assembly 210′ is attached to the support frame 302, the removable adhesive layer 106 can be removed by pulling on the pull tab 108, to release the removable adhesive layer 106 and the rigid carrier 102 from the remainder of the assembly shown in FIG. 3, including the plastic lens 104, the display panel 202, and the support frame 302.

After removing the rigid carrier 102 and the removable adhesive layer 106, a replaceable lens 402 (e.g., a replaceable plastic transparent layer) can be attached to an upper surface of the plastic lens 104, as shown in FIG. 4. The replaceable lens 402 can be a customer replaceable lens, such that the customer can peel off the replaceable lens 402 and replace with a new lens. Since the plastic lens 104 may be scratched, the replaceable lens 402 provides protection for the plastic lens 104. In other examples, where the plastic lens 104 is scratch resistant, the replaceable lens 402 does not have to be added.

The various stages depicted by FIGS. 1-4 can be performed by multiple respective entities. For example, the lens sub-assembly 110 of FIG. 1 can be made by a cover lens supplier, which can manufacture (e.g., assemble) the lens sub-assembly 110 (by attaching the rigid carrier 102 to the plastic lens 104) and ship the lens sub-assembly 110 to a display assembly supplier that assembles the lens sub-assembly 110 with the display sub-assembly 200 into the lens-display assembly 210 as shown in FIG. 2. The display assembly supplier can in turn ship the lens-display assembly 210 to a device manufacturer (that manufactures a display device or an electronic device) in which the display panel 202 is to be provided. The device manufacturer can form the assemblies shown in FIGS. 3 and 4, in some examples.

In alternative examples, the same entity can perform each of the processes shown in FIGS. 1-4.

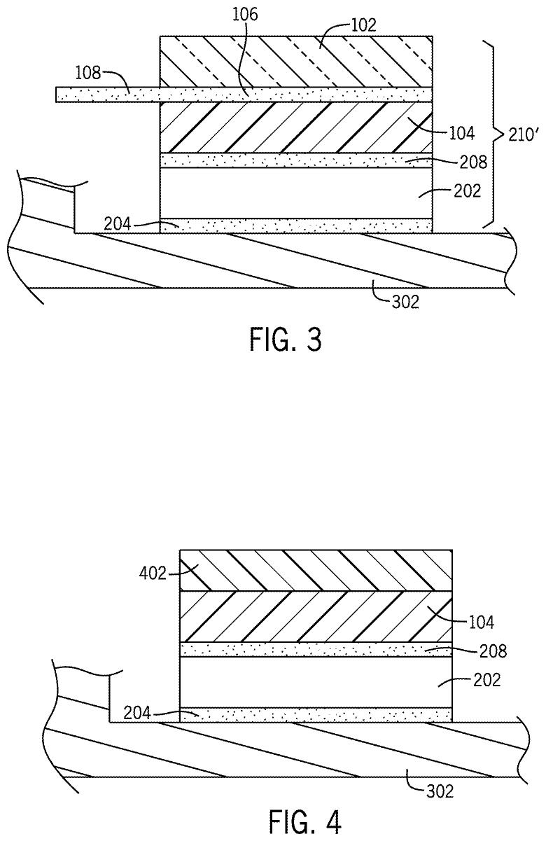

FIG. 5 is a simplified sectional view of an assembly that includes the display panel 202, the plastic layer 104 attached by the adhesive layer 208 to a display surface of the display panel 202, and the transparent rigid carrier 102 to support the plastic layer 104 and the display panel 202. The assembly further includes the removable fastener 106 to attach the plastic layer 104 to the transparent rigid carrier 202, where the removable fastener 106 is to release the transparent rigid carrier 102 from the plastic layer 104.

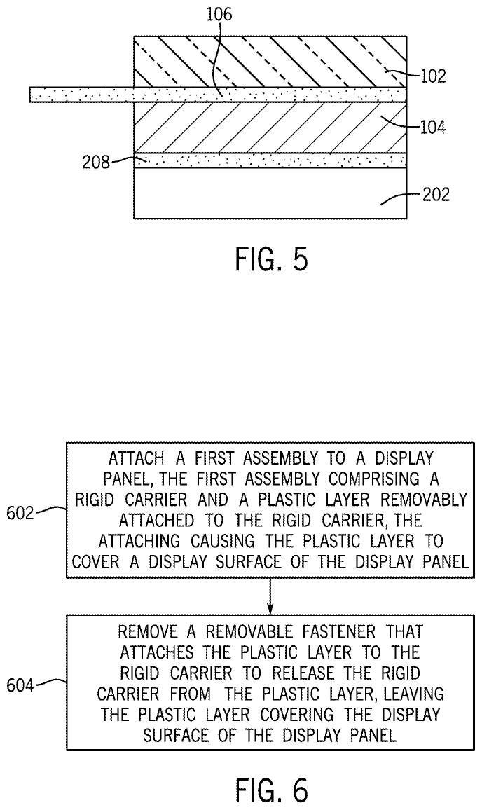

FIG. 6 is a flow diagram of a process of manufacturing a device, according to some examples. The manufacturing process attaches (at 602) a first assembly to a display panel, the first assembly including a rigid carrier and a plastic layer removably attached to the rigid layer, the attaching causing the plastic layer to cover a display surface of the display panel. The manufacturing process further includes removing (at 604) a removable fastener that attaches the plastic layer to the rigid carrier to release the rigid carrier from the plastic layer, leaving the plastic layer covering the display surface of the display panel.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An assembly comprising:
a plastic layer to cover a surface of a display panel;
a rigid carrier to support the plastic layer; and
a removable fastener to attach the plastic layer to the rigid carrier, the removable fastener to release the rigid carrier from the plastic layer.

2. The assembly of claim 1, further comprising the display panel, wherein the plastic layer is attached to the surface of the display panel, and
the removable fastener is to release the rigid carrier from a sub-assembly of the plastic layer and the display panel.

3. The assembly of claim 2, further comprising an adhesive layer to attach the plastic layer to the surface of the display panel.

4. The assembly of claim 3, wherein the adhesive layer is curable by ultraviolet light passed through the rigid carrier.

5. The assembly of claim 3, wherein a sub-assembly comprising the rigid carrier, the plastic layer, and the adhesive layer is to attach to the surface of the display panel.

6. The assembly of claim 2, wherein the display panel comprises a plastic display panel.

7. The assembly of claim 1, wherein the rigid carrier is formed of a transparent material.

8. The assembly of claim 7, wherein the transparent material comprises glass.

9. The assembly of claim 1, wherein the releasable fastener comprises a releasable adhesive.

10. A method of manufacturing a device, comprising:
attaching a first assembly to a display panel, the first assembly comprising a rigid carrier and a plastic layer removably attached to the rigid carrier, the attaching causing the plastic layer to cover a display surface of the display panel; and
removing a removable fastener that attaches the plastic layer to the rigid carrier to release the rigid carrier from the plastic layer, leaving the plastic layer covering the display surface of the display panel.

11. The method of claim 10, further comprising:
attaching an assembly comprising the rigid carrier, the plastic layer, and the display panel to a support frame of the display device prior to performing the removing.

12. The method of claim 10, wherein attaching the first assembly to the display panel comprises attaching the plastic layer to the display surface of the display panel using an ultraviolet-light curable adhesive layer.

13. The method of claim 10, further comprising:
after the removing of the removable fastener that attaches the plastic layer to the rigid carrier to release the rigid carrier from the plastic layer, mounting a replaceable transparent layer on the plastic layer.

14. An assembly comprising:
a display panel;
a plastic lens attached by an adhesive to a display surface of the display panel;
a transparent rigid carrier to support the plastic layer and the display panel; and
a removable fastener to attach the plastic layer to the transparent rigid carrier, the removable fastener to release the transparent rigid carrier from the plastic lens.

15. The assembly of claim 14, wherein the display panel comprises a plastic organic light-emitting diode display panel.
